(19) United States
(12) Patent Application Publication
(10) Pub. No.: US 2024/0195491 A1
(43) Pub. Date: Jun. 13, 2024

(54) SPLITTING BACKHAUL TRAFFIC OVER MULTIPLE SATELLITES

(71) Applicant: Hughes Network Systems, LLC, Germantown, MD (US)

(72) Inventors: Bhanu Durvasula, Potomac, MD (US); Gaguk Zakaria, College Park, MD (US)

(21) Appl. No.: 18/533,519

(22) Filed: Dec. 8, 2023

Related U.S. Application Data
(60) Provisional application No. 63/431,189, filed on Dec. 8, 2022.

(51) Int. Cl. H04B 7/185

(52) U.S. Cl. CPC H04B 7/18539; H04B 7/18513

(57) ABSTRACT

Methods, systems, and apparatus, including computer programs encoded on computer-storage media, for a splitting backhaul traffic over multiple satellites. In some implementations, a system includes a two satellite terminals, each configured to communicate over a different satellite network connection. The two satellite network connections involve different terrestrial satellite gateways and may involve different satellites. The system includes a communication subsystem that is configured to use the satellite network connections as backhaul links for one or more wireless base stations, and to split traffic among the satellite network connections according to the category of traffic. For example, the communication subsystem is configured to split traffic among the two satellite network connections such that (i) a first category of traffic is provided over the first satellite network connection and (ii) a second category of traffic is provided over the second satellite network connection.

### CROSS-REFERENCE TO RELATED APPLICATIONS

This application claims priority to U.S. Provisional Patent Application No. 63/431,189, filed on Dec. 8, 2022, the entirety of which is incorporated by reference herein.

### BACKGROUND

The present specification relates to wireless communication systems, and the integration of multiple types of communication technologies (e.g., satellite communication networks, cellular networks, etc.).

Communication networks have become increasingly capable and complex as the number of devices and the number of networked devices has increased. In many cases, it is desirable for communication networks to span large geographic areas, including many different types of terrain and different countries. The capabilities of one communication technology, such as cellular communication networks, may not provide the capabilities needed for all regions where service is needed.

### SUMMARY

In some implementations, a communication system provides cellular connectivity using a satellite backhaul. The system can achieve high efficiency and low effective latency by splitting network traffic between two different satellites. For example, a first satellite communication link with low latency can be used to carry voice traffic and signaling data. Concurrently, a second satellite communication link with higher latency but lower costs or higher bandwidth available can be used to carry other types of traffic, such as Internet data that is not as sensitive to delay. As a result, cellular traffic from a region can be split routed over the two different satellite communication links to combine the benefits both satellite communication links. For example, low latency is achieved for delay-sensitive traffic (e.g., voice calls, connection signaling, etc.) while overall costs are reduced by routing other traffic through a less-expensive connection.

The system can be used to provide a satellite backhaul to support cellular connectivity in many different regions, including rural areas. Many rural or remote areas do not have a reliable terrestrial backhaul to carry traffic between local cellular base stations and a core network. For these rural and remote areas, a satellite backhaul is an excellent option to connect the base stations to the core network. Nevertheless, some countries or other regions have limited satellite bandwidth available to support cellular service. For example, the amount of available satellite bandwidth that lands in a country (e.g., is handled by a terrestrial satellite gateway located in the country) may be very limited and is very expensive as a result. There may be satellite links with much more available bandwidth that land outside the country (e.g., are handled by a terrestrial satellite gateway located outside the country). However, even with high available bandwidth and low cost, satellite links that land outside the country may incur significantly higher latency that would cause unacceptable delay in voice calls or signaling traffic.

To provide an efficient satellite backhaul, a system can split traffic from one or more base stations over two (or more) different satellite connections. Some classes of traffic, such as voice traffic and signaling traffic, are routed over a first satellite link having low latency, such as a satellite link that lands traffic at a gateway in the same country as the base station. Other classes of traffic are routed over a second satellite link that has higher latency, such as a satellite link that lands traffic at a gateway in different country than the one where the base station is located. This allows the system to keep latency low for delay-sensitive traffic, while also conserving limited in-country bandwidth and reducing costs by routing delay-insensitive traffic to other satellite links where bandwidth is cheaper and more plentiful.

The system can split a base station's traffic into different paths or different satellite links using a network component between one or more cellular base stations and the core network. For example, one or more base stations can connect through a small-footprint, low-cost core network subsystem, which may be located at or near the area where the one or more base stations are located. For example, the subsystem can be an 3rd Generation Partnership Project (3GPP) Long-Term Evolution (LTE) Evolved Packet Core (EPC) or a 3GPP Fifth Generation (5G) core (5GC). The subsystem provides core network functionality between two radio access networks, such as the cellular network provided by nearby base stations and the satellite network that provides wireless backhaul.

The subsystem is associated with two satellite terminals, such as very small aperture terminals (VSATs), can carry traffic to and from the subsystem on different satellite connections. For example, a first terminal communicates via a first satellite with a first satellite gateway located in the same region or country as the base station, and a second terminal communicates via a second satellite with a second satellite gateway located in a different region or country that is different from where the base station is located. The subsystem divides traffic so that voice traffic and signaling traffic is routed to the first satellite terminal that lands in-country and has the lowest-latency connection, while user data traffic is routed to the second satellite terminal that lands traffic in a different country. As a result, a majority of the total network traffic from the base station can be routed over the network path that carries higher bandwidth and has lower bandwidth costs. To permit lawful intercepts as needed, voice traffic or data traffic that needs to be intercepted is carried over the satellite connection that provides in-country landing.

In one general aspect, a system includes: a first satellite terminal configured to communicate over a first satellite network connection with a first satellite gateway located in a first geographic region; a second satellite terminal configured to communicate over a second satellite network connection with a second satellite gateway located in a second geographic region; and a communication subsystem that is configured to concurrently communicate with the first satellite terminal and the second satellite terminal, wherein the communication subsystem is configured to use the first satellite network connection and the second satellite network connection as backhaul links for one or more wireless base stations. The communication subsystem has a communication interface for communication with the one or more wireless base stations, wherein the communication interface is configured to send and receive traffic for the one or more wireless base stations. The communication subsystem is configured to split the traffic among the first satellite network connection and the second satellite network connection such that (i) a first category of traffic is provided over the first satellite network connection and (ii) a second category of traffic is provided over the second satellite network connection.

Implementations can include one or more of the following features. For example, in some implementations, the communication interface is configured to send and receive voice traffic and data traffic for the one or more wireless base stations. The first satellite network connection has a lower latency than the second satellite network connection. The first category of traffic is voice traffic, such that the communication subsystem is configured to provide voice traffic over the first satellite network connection of the first satellite terminal. The second category of traffic is data traffic, such that the communication subsystem is configured to provide the data traffic over the second satellite network connection of the second satellite terminal.

In some implementations, the communication subsystem is configured to exchange, over the first satellite networking connection, signaling messages for setting up or terminating communication sessions.

In some implementations, the first satellite network connection comprises a satellite link with a first satellite, and the first satellite gateway is located in a first country that is the same country where the base station is located. The second satellite network connection comprises a satellite link with a second satellite, and the second satellite gateway is located in a second country.

In some implementations, the first satellite network connection and the second satellite network connection comprise different physical network paths, including communication through at least a different frequency band, physical channel, satellite beam, or satellite.

In some implementations, the first satellite terminal is a first very small aperture terminal (VSAT) and the second satellite terminal is a second VSAT.

In some implementations, the communication subsystem comprises a local core network that is co-located with the first satellite terminal and the second satellite terminal.

In some implementations, the communication subsystem, the first satellite terminal and the second satellite terminal are all located at the same building or facility.

In some implementations, the communication subsystem, the first satellite terminal and the second satellite terminal are all located within an area with a radius of one mile or less.

In some implementations, the communication subsystem, the first satellite terminal and the second satellite terminal are the communication subsystem comprises a 3rd Generation Partnership Project (3GPP) long-term evolution (LTE) Evolved Packet Core (EPC) or a 3GPP fifth generation (5G) core (5GC).

In some implementations, the communication subsystem, the first satellite terminal and the second satellite terminal are the communication interface comprises at least one of (i) a LTE S1 interface or a (ii) 5G Next Generation (NG) interface.

In some implementations, the communication subsystem comprises: a serving gateway that provides the communication interface for communication with the one or more wireless base stations; and a packet gateway that is configured to split voice traffic and data traffic among the satellite network connections.

In some implementations, the communication subsystem comprises: a mobility management entity configured to manage access to network connections by user equipment; and a policy and charging rules function that is configured to perform data flow detection, policy enforcement, and charging for network resource use.

In another general aspect, a method includes: establishing multiple concurrent satellite network connections, the satellite networking connections comprising (i) a first satellite network connection involving a first satellite gateway in a first geographic region, and (ii) a second satellite network connection involving a second satellite gateway located in a second geographic region; communicating with one or more wireless base stations to send traffic to and receive traffic from the one or more wireless base stations; and splitting backhaul communication among the multiple concurrent satellite network connections to route different categories of traffic for the one or more wireless base stations over different satellite network connections, including (i) routing traffic that is in a first category to the first satellite network connection, and (ii) routing traffic that is in a second category to the second satellite network connection.

Implementations can include one or more of the following features. For example, in some implementations, the first satellite network connection has a lower latency than the second satellite network connection.

In some implementations, the first geographic region is a first country, and wherein the second geographic region is a second country that is different from the first country. The one or more wireless base stations are located in the first country; the first category comprises voice traffic, such that the voice traffic is routed over the first satellite network connection involving the first satellite gateway that is located in the first country; and the second category comprises Internet data traffic, such that the Internet data traffic is routed over the second satellite network connection involving the second satellite gateway that is located in the second country.

In some implementations, the different categories of traffic are different quality of service classes.

In some implementations, the first satellite network connection comprises a satellite link with a first satellite, and the first satellite gateway is located in a first country that is the same country where the one or more wireless base stations are located; and the second satellite network connection comprises a satellite link with a second satellite, and the second satellite gateway is located in a second country.

In some implementations, the first satellite network connection and the second satellite network connection comprise different physical network paths, including communication through at least a different frequency band, physical channel, satellite beam, or satellite.

In some implementations, splitting backhaul communication among the multiple concurrent satellite network connections comprises routing signaling traffic for the first satellite network connection and the second satellite network connection over the first satellite network connection.

In some implementations, splitting the backhaul communication is performed by a 3rd Generation Partnership Project (3GPP) long-term evolution (LTE) Evolved Packet Core (EPC) or a 3GPP fifth generation (5G) core (5GC).

Other embodiments of these and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram showing an example of a communication system that uses multiple satellite links as satellite backhaul to support cellular connectivity.

FIG. 2 is a block diagram showing an example of additional aspects of the communication system.

FIGS. 3 and 4 are diagrams showing examples of interactions to support call flow roaming.

Like reference numbers and designations in the various drawings indicate like elements.

### DETAILED DESCRIPTION

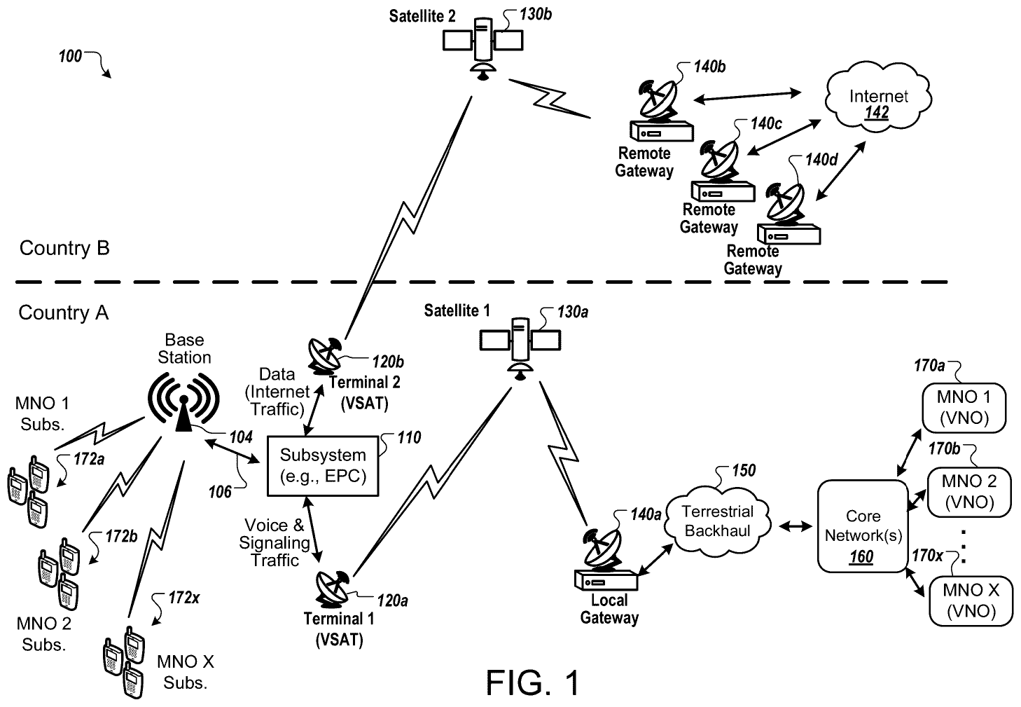

FIG. 1 shows a diagram of an example communication system 100 that uses multiple satellite links as satellite backhaul to support cellular connectivity. The system 100 includes a base station 104 (e.g., a wireless base station or cellular base station) that provides cellular connectivity to a variety of groups of user devices 172a-172x. The base station 104 is located in an area where a wired backhaul is not available, and so the base station 104 uses a satellite backhaul to communicate with the core network 160 and the Internet 142. The satellite backhaul functionality is provided by a subsystem 110 and two satellite terminals 120a, 120b. The subsystem 110 acts as a low-cost, local core network for the base station 104 and potentially other base stations in the local area. For example, the subsystem 110 can implement the functions of an Evolved Packet Core (EPC) according to the 3GPP LTE standard. In addition, or as an alternative, the subsystem 110 can implement the functions of a 5G core (5GC).

The subsystem 110 divides traffic from the base station 104 among the two satellite terminals 120a, 120b so that both are used concurrently. For example, the subsystem 110 can route delay-sensitive traffic (e.g., voice traffic, signaling traffic) over a satellite connection that is handled by a local satellite gateway 140a (e.g., a gateway in the same country as the base station 104) to provide low latency. The subsystem 110 can route other traffic (e.g., user data and Internet traffic) over a second satellite connection handled by a remote satellite gateway (e.g., a gateway in a different country with respect to the base station 104) to take advantage of higher available bandwidth and lower costs for carrying traffic that can tolerate higher latency. The base station 104 can operate in a standard manner and sees only one connection to the subsystem 110. The subsystem 110 handles the routing of traffic so that the complexity is hidden from the base station 104 and the process is transparent or invisible to the base station 104.

In general, it can be challenging to provide cellular service in areas that are rural, remote, or sparsely populated and so do not have reliable network infrastructure that can support wired backhaul links for communications between cellular base stations and core networks. Satellite connections are available over a wide geographic area and so are well-suited for backhaul role. For example, a satellite connection between a base station and a terrestrial satellite gateway in the same country can serve as the backhaul. In many regions, however, satellite bandwidth is limited for terrestrial satellite gateways in the region, and so a satellite backhaul routing voice traffic and data traffic to an in-country gateway may have limited bandwidth, congestion, and high costs. Greater bandwidth and lower costs may be available using satellite connections with gateways in other regions (e.g., in other countries), but using connections with more distant gateways can significantly increase latency, and many satellite terminals can only support one satellite connection at a time.

The example illustrated in FIG. 1 shows how two satellite connections can be used concurrently, with coordination by the subsystem 110, to increase the available bandwidth for a cellular network while providing low latency for delay-sensitive traffic. The subsystem 110 utilizes multiple terminals 120a, 120b to maintain separate satellite connections. For example, the subsystem routes voice traffic and signaling traffic through a first terminal 120a that communicates over a satellite network connection involving a local gateway 140a located in the same country. The signaling traffic can include messages used to set up or terminate communication sessions, including non-access stratum (NAS) signaling to setup or to finish a 4G or 5G session, or SIP signaling to start or to finish a voice session. The subsystem 110 routes other traffic (e.g., Internet traffic) through a second terminal 120b that communicates with a remote gateway 140b located in a different country. The subsystem 110 can act as a small-footprint local core network for the base station 104 and potentially one or more other base stations. Unlike a traditional core network, the subsystem 110 connects between two radio access networks, a cellular access network of the base station 104 and the satellite network used as backhaul. The subsystem 110 does not have a separate connection to the Internet or to another core network except through the satellite backhaul provided using the terminals 120a, 120b.

In further detail, the base station 104 may be a cellular base station, such as an E-UTRAN Node B or evolved Node B (eNB) of a Fourth Generation (4G) LTE radio access network (RAN) or a Next-Generation Node B (gNB) of a Fifth Generation (5G) New Radio (NR) RAN. The example of FIG. 1 shows a single base station 104 using satellite backhaul using the subsystem 110 and satellite terminals 120a, 120b. In some implementations, multiple base stations 104 may each communicate with the subsystem 110 and rely on the subsystem 110 and its associated terminals 120a, 120b for satellite backhaul. In other implementations, individual base stations 104 may each have a separate instance of the subsystem 110 and corresponding pair of terminals 120a, 120b.

The base station 104 typically has a wired connection with the subsystem 110, but a wireless connection could optionally be used. The subsystem 110 and the terminals 120a, 120b can be co-located, for example, the subsystem 110 and the terminals 120a, 120b may be located within a mile of each other or less (e.g., within half a mile, a quarter of a mile, 500 ft, 200 ft, 50 ft, etc.). In some cases the subsystem 110 and the terminals 120a, 120b are located at the same site, such as at the same building or cell tower, or even integrated into a single device or module. Optionally, the base station 104 can be co-located with the subsystem 110 and/or the terminals 120a, 120b.

The terminals 120a, 120b can be very small aperture terminals (VSATs), and each only needs to support one satellite connection at a time. In the system 100, the subsystem handles control plane communications with the base station 104 through a communication interface 106 such as an S1 interface for LTE base stations (e.g., eNBs) or NG interface for 5G base stations (e.g., gNBs). As a result, the terminals 120a, 120b do not need to provide these interface and can simply transfer packet-based traffic (e.g., Internet Protocol packets) without the need for the terminals 120a, 120b to implement control plane functions for the cellular network.

In the example, each of the terminals 120a, 120b communicates with a different satellite 130a, 130b. More generally, the terminals 120a, 120b communicate over different wireless paths or physical channels, which may involve the same satellite or multiple satellites. The wireless paths used in the satellite network connections of the terminals 120a, 120b may use different frequency bands, polarizations, channels, satellite beams, and/or satellites.

In the example, the two satellites 130a, 130b communicate with gateways 140a, 140b in different geographic regions. For example, the local gateway 140a is located in a first geographic region, e.g., Country A, with the base station 104. The remote gateway 140b is located in a second geographic region, e.g., Country B. More generally, the two gateways 140a, 140b may be located in different geographic regions, or at different distances from the terminals 120a, 120b so that the latency is lower for the connection to the local gateway 140a than for the connection to the remote gateway 140b. The greater latency for the second satellite connection may be due to greater physical distance that wireless signals travel to the remote gateway 140b than to the local gateway 140a and/or due to a greater number of wired network routing connections or “hops” and greater distance along terrestrial wired networks from the remote gateway 140b in Country B to reach sites in Country A. Even within a single country, the techniques of splitting backhaul traffic among multiple satellite network connections that respectively use different gateways 140 can improve efficiency. For example, one satellite, satellite beam, or local gateway may have limited available bandwidth, and routing delay-insensitive traffic through a network connection utilizing a more distant gateway 140 can still increase the amount of bandwidth available and may reduce costs and increase overall quality of service.

In the example, multiple remote gateways 140b-140d are illustrated. The system may select an appropriate gateway 140b-140d based on availability, amount of bandwidth available, throughput, latency, bandwidth costs, or other factors.

In the system 100, several different mobile network operators (MNOs) 170a-170x act as virtual network operators that can make provide connectivity to their subscribers through the base station 104. These MNOs 170a-170x typically do not operate or manage the base station 104 or the subsystem 110 and the terminals 120a, 120b. Nevertheless, through roaming or other processes, the subscribers of the MNOs 170a-170x can obtain cellular connectivity through the base station 104 when they are in the area. There are three groups of user devices of subscribers shown, user devices 172a for subscribers of MNO 1 170a, user devices 172b for subscribers of MNO 1 170b, and user devices 172x for subscribers of MNO X 170x.

The user devices 172a-172x send and receive over their local wireless connections with the base station 104. The user devices 172a-172x communicate with the base station 104 exchange voice traffic for phone calls as well as data traffic for Internet communications (e.g., web browsing, file transfer, media streaming, etc.).

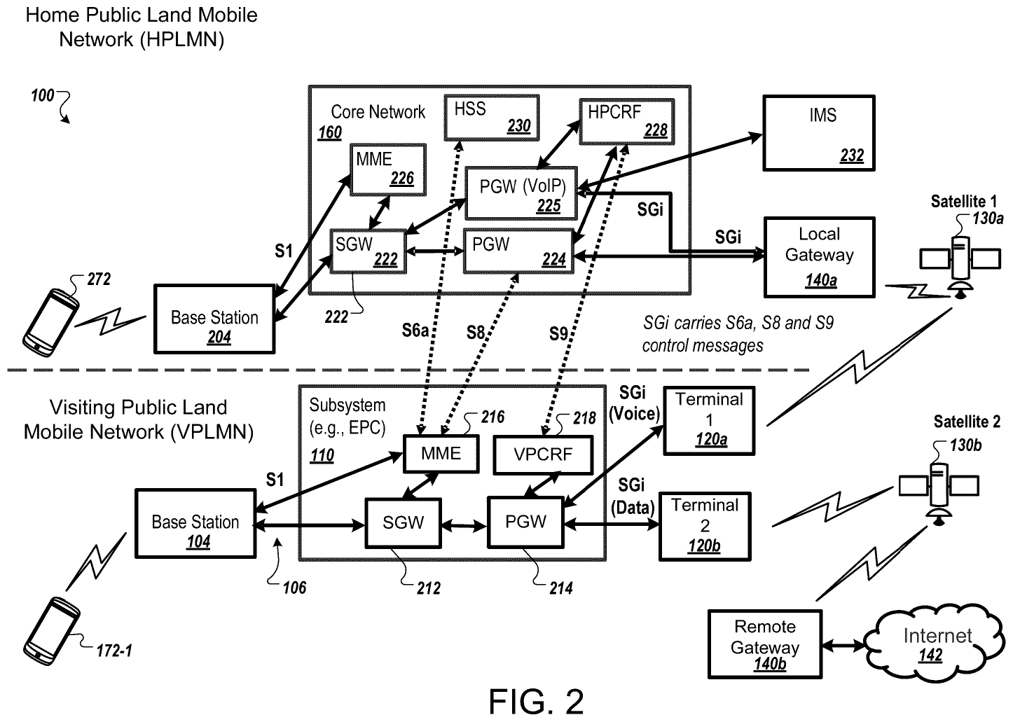

For reverse channel communication, the base station 104 receives transmissions of the user devices 172a-172x and forwards packets with the information to the subsystem 110 over a communication interface 106, which is typically wired and may include an S1 interface for 4G/LTE or an NG interface for 5G. The subsystem 110 handles various network core network functions, such as mobility management, as discussed below with respect to FIG. 2.

The subsystem 110 also classifies the traffic from the user devices 172a-172x and divides it to route the most delay-sensitive traffic to the first terminal 120a and to route other traffic 120b to the second terminal 120b. For example, the subsystem 110 can classify the traffic into different categories according to quality of service (QoS) classes, or classify the type of traffic (e.g., voice traffic, user data traffic, control signaling traffic, etc.). The base station 104 is not aware that traffic is being split among multiple satellite network paths, and the split does not affect the operation of the base station 104. In addition, because the subsystem 110 handles control functions and acts as a local core network, the terminals 120a, 120b can simply transfer packet data without the need to perform cellular core network functions.

The terminals 120a, 120b transfer the data they receive over their respective satellite network connections. The first terminal 120a send transmissions to the satellite 130a, which forwards the data to the local gateway 140a, which then passes received data over a wired terrestrial backhaul 150 to a core network 160. In the illustrated example, only one core network 160 is shown. Nevertheless, each MNO 170a-170x can have its own core network, for example, MNO 170a can have one core network, MNO 170b can have another core network, and so on, where all of the core networks are connected to the local terminal 140a via the terrestrial backhaul 150.

The various MNOs 170a-170x communicate with the core network 160 to provide data for voice calls and other features they provide to subscribers. Similarly, signaling traffic is also provided through the connection with the local gateway 140a, as many control functions are time-critical or have time-out periods that would be impacted by high latency. Generally, signaling refers to the procedures and messages used to start or finish a communication session. Examples of signaling traffic include signals for paging, roaming, voice call initiation, voice call termination, and so on. The subsystem 110 coordinates with the core network 160 for some functions, such as authentication, and this coordination takes place over the satellite connection with the first terminal 120a and local gateway 140a to achieve low latency. The second terminal 120b send transmissions to the satellite 130b, which forwards the data to the remote gateway 140b, which then passes the packets of Internet traffic on to the Internet 142.

Forward channel communication operates in a similar manner. Voice traffic and signaling traffic is routed through the core network 160 and the terrestrial backhaul 150 to the local gateway 140a, then through the satellite network connection from the local gateway 140a through the satellite 130a to the first terminal 120a, and to the subsystem 110. Internet traffic for the user devices 172a-172x is sent to the remote gateway 140b, then through the satellite network connection from the remote gateway 140b through the satellite 130b to the second terminal 120b, and to the subsystem 110. The subsystem 110 transmits traffic for the user devices 172a-172x, from both of the terminals 120a, 120b, to the base station 104 through the communication interface 106, and the base station 104 transmits the data to the user devices 172a-172x.

FIG. 2 is a block diagram showing an example of additional aspects of the communication system 100, including interface details for implementing split traffic among multiple satellite backhaul connections. The figure shows additional functions or components of the subsystem 110 and how the subsystem 110 coordinates with the core network 160.

In the example, the core network 160 is part of a home network, e.g., the network of an MNO hosted by the core network 160. A user device 172-1 is a device of a subscriber to one of the MNOs 170a-170x, and the user device 172-1 is currently roaming in the area of the base station 104. The user device 172-1 is involved in a voice call with another user device 272, which gains connectivity through a remote base station 204 supported by the core network 160. FIG. 2 shows coordination between a home public land mobile network (HPLMN) including the core network 160 that hosts the MNOs 170a-170x of FIG. 1. The subsystem is part of a visiting public land mobile network (VPLMN), where core network functionality is provided by the subsystem 110 to the user device 172-1 that is roaming.

The subsystem 110 is shown as implementing functions of the EPC, and so includes a Serving Gateway (SGW) 212, a Packet Data Network Gateway (PGW or “packet gateway”) 214, a Mobility Management Entity (MME) 216), and a Visiting Policy and Charging Rules Function (VPCRF) 218.

The SGW 212 is a data plane element that manages user-plane mobility and provides an interface to the RAN (e.g., cellular network of the base station 104). In the example, the communication interface 106 is an S1 interface. The SGW 212 maintains data paths between the base station 104 (e.g., an eNB) and the PGW 214. From a functional perspective, the SGW 212 is the termination point of the packet data network interface towards the Evolved UMTS Terrestrial Radio Access (E-UTRAN). When terminals move, the SGW 212 serves as a local mobility anchor, so that packets are routed through this point.

The PGW 214 provides an interface toward one or more packet data network(s) and serves as an anchor point for sessions over these networks. The PGW 214 can, among other actions, act to enforce policies for resource allocation and usage and can perform packet classification and packet filtering (including deep packet inspection for application type detection). In LTE, data plane traffic is carried over virtual connections called service data flows (SDFs), and the SDFs are in turn, are carried over bearers, which are virtual containers with unique QoS characteristics. In general, an SDF is a group of IP flows associated with a service that a user is using, and a bearer is a collection of SDFs that have the same QoS classification. In the system 100, the PGW 214 classifies traffic into at least two categories, and then maps those categories to the two different satellite backhaul connections. For example, the PGW 214 classifies traffic into different categories of traffic, such as voice traffic, signaling traffic, and Internet traffic. The PGW 214 routes voice traffic and signaling traffic to the first satellite connection (e.g., involving the first terminal 120a and first satellite 130a), and routes the Internet traffic (and potentially any other types of traffic) over the second satellite connection (e.g., involving the second terminal 120b and the second satellite 130b). For traffic received over the satellite backhaul, the PGW 214 provides the data to the SGW 212 which shows a single unified connection for voice traffic and data traffic to the base station 104.

The MME 216 performs the signaling and control functions to manage the User Equipment (UE) access to network connections, the assignment of network resources, and the management of the mobility states to support tracking, paging, roaming and handovers. Often, the MME 216 controls all control plane functions related to subscriber and session management. Because the subsystem 110 is intended to support a relatively small number of base stations 104, the MME 216 can operate at a much smaller scale than the MME of a typical core network. For example, while the core network 160 may be configured to support hundreds or thousands of base stations, but the subsystem 110 may be configured to support significantly fewer (e.g., 100, 50, 20, 10, 5, 2, 1). The MME 216 perform bearer management control functions to establish the bearer paths that the user devices (e.g., user equipment) use. The MME 216 supports various functions such as: (1) Security procedures, such as end-user authentication as well as initiation and negotiation of ciphering and integrity protection algorithms; (2) terminal-to-network session handling, including signaling procedures used to set up packet data context and negotiate associated parameters like QoS; and (3) idle terminal location management, including tracking area update processes used to enable the network to join terminals for incoming sessions.

The VPCRF 218 represents the functional entity that supports service data flow detection, policy enforcement, and flow-based charging (e.g., assigning costs for services or resources consumed).

The core network 160 implements a number of core network functions similar to those discussed above, such as an SGW 222, PGW 224, and MME 226. The MME 226, however, can be configured to support hundreds or even thousands of base stations, as the core network 160 may be part of a dense urban cellular network. The core network 160 has a home policy and charging rate function (HPCRF), which supports service data flow detection, policy enforcement, and flow-based charging. The core network 160 has a few additional elements, such as an additional PGW 225 for voice over IP (VoIP) traffic. The core network 160 also includes a Home Subscriber Server (HSS) 230, which can act as a master database subscriber information and can include a central repository of information for network nodes. The HSS can store subscriber-related information including user identification information, security information, location information, and subscription profiles.

The core network 160 has an associated IP Multimedia Subsystem (IMS) 232, which supports IP-based real time services such as voice, video-telephony, and short message service (SMS) messaging. Communication between the subscribers uses packet-switched connections which are able to guarantee defined qualities of service (QoS) end-to-end. IMS allows services to operate independently from the access network and can be charged according to service. The IMS 232 and VoIP PGW 225 cooperate to provide VoIP services and other media services.

When one core network works with another core network to support roaming subscribers, coordination is needed. In FIG. 2, dashed lines show communication between the elements of the core network 160 and the subsystem 110. Note that the dotted lines show the type of communication that occurs or the endpoints of the communication, not the physical path that the messages follow. For example, the signaling and communication between the core network 160 and the subsystem 110 takes place over the satellite network connection involving the local gateway 130a and the first terminal 120a. These communications can take place between elements of the core network 160 and the subsystem 110 and include control messages sent over the S6a, S8, and S9 interfaces as labeled and indicated with dotted lines. The packets of the actual messages sent over these interfaces are sent over the satellite backhaul connections. For example, the messages are sent as packets over the SGi interfaces from the PGW 214 to the terminal 120a and between the PGW 224 and PGW 225 and the local gateway 140a.

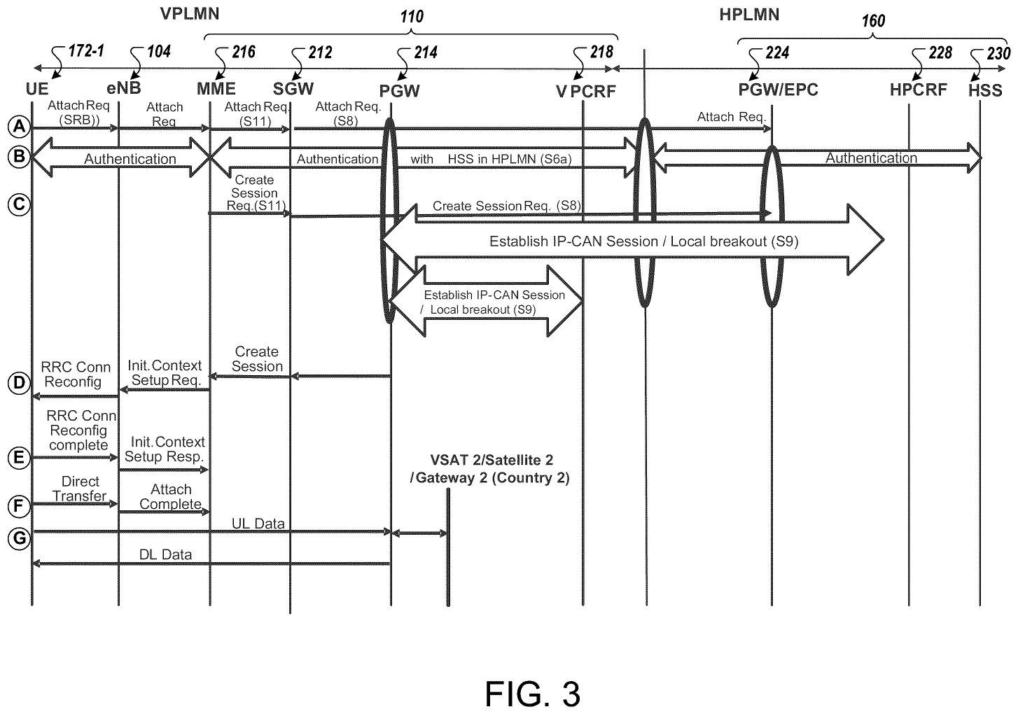

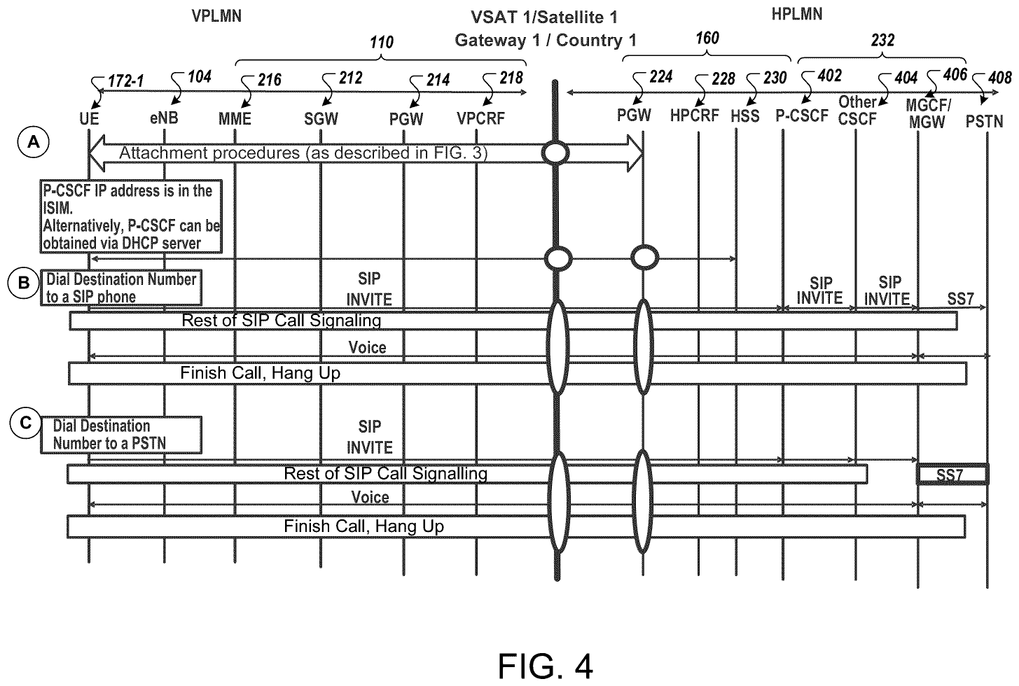

When a subscriber from one of the MNOs arrives near the base station 104, the subsystem 110 does not have a database of subscriber information to authenticate the subscriber and determine the level of service to provide. The subsystem 110 communicates with the core network 160 (over the backhaul provided by the satellite connection of the first satellite terminal 120a), with the MME 216 obtaining information about the subscriber from the HSS 230 over the S6a interface. Once the subscriber is authenticated and is confirmed to be a valid user to be in the network, the subscriber is granted access to data communication, sessions, and call sessions. When a visiting subscriber makes a voice call, coordination with the home network is needed because the visiting network can handle data termination but does not have the capabilities of the IMS 232, HSS 230, and so on. Even if the subsystem 110 includes a subscriber database or caches information about subscribers, it still needs to synchronize with the core network 160 to reflect addition or removal of subscribers, changes in service level authorized, and so on. After authentication, the subscriber can initiate calls and other interactions, which can involve communication over the S8 interface. Other interactions are described with respect to FIGS. 3 and 4.

FIG. 3 is a diagram that shows examples of interactions to support call flow roaming in the system 110 that supports split satellite backhaul. For example, the figure shows data connection call setup for Local Breakout (LBO). This enables a MNO to break out Internet sessions into the home network, to provide inbound roaming subscribers with an ability to order data, which is provided directly by the visited network. FIG. 3 shows a flow of data and operations in various stages labeled (A)-(G).

In stage (A), the user device 172-1 sends an attachment request on the signaling radio bearer SRB to the base station 104. The base station 104 sends the attachment request to the MME 216 of the subsystem 110, which passes the attachment request to the SGW 212 via an S11 interface. The SGW 212 sends the attachment request to the PGW 214 via an S8 interface. The PGW 214 sends the attachment request through the satellite backhaul connection with the first terminal 120A and the local gateway 130a to the PGW 224 of the core network 160.

In stage (B), authentication of the subscriber proceeds. This involves interactions between the user device 172-1 and the MME 216, as well as communication between the MME 216 and the HSS 230 of the home network via the S6a interface.

In stage (C), after authentication is successful, the MME 216 initiates creation of a session and sends the session request to the SGW 212 via an S11 interface, and the SGW-12 sends the session request via the S8 interface to the PGW 224 in response, and IP-CAN session is established involving local breakout. This process involves communication over the S9 interface, and involves both the VPCRF 218 and the HPCRF 228.

In stage (D), the session is created and radio resource control RRC connection is configured. For example, communications to create the session are made with the MME 216, which sends an initial context setup request to the base station 104, which sends an RRC connection reconfiguration message to the user device 172-1.

In stage (E), communications are provided to indicate that the RRC connection reconfiguration is complete, and the initial context setup response is provided to the MME 216.

In stage (F), a direct transfer from the user device 172-1 to the base station 104 is performed, and attachment complete procedure is performed from the base station 104 to the MME 216. At this point, the connection has been established for the user device 172-1 to send and receive data traffic in the network. At this point, coordination with the core network 160 to establish the session, and signaling for the connection is performed over the local, low-latency satellite backhaul connection using the first satellite terminal 120a and local gateway 130A that lands traffic in the same country as the base station 104. Once the connection and session are complete, user data traffic is carried over the second satellite network backhaul connection, which uses the second terminal 120b and the remote gateway 130b.

In stage (G), the user device 172-1 sends uplink (UL) data through the base station 104 and the subsystem 110 to the Internet, and the subsystem 110 sends the uplink data over the second satellite network connection involving the remote gateway 130B. In addition, the user device 172-1 receives downlink (DL) data, which is received from the Internet through the second satellite network connection (e.g., through the second terminal 120b and the remote gateway 130b) as backhaul.

FIG. 4 is a diagram that shows examples of interaction that support IMS voice over LTE call setup with home route. In the example, the user device 172-1 initiates a call and the call setup and voice traffic are both carried over the satellite network connection having the lowest latency, e.g., the connection involving the first satellite terminal 128 and the local gateway 130A. FIG. 4 shows a flow of data and operations that are labeled stages (A) through (C). The example shows two examples of call initiation, one using session initiation protocol (SIP) and another for a public switched telephone network (PSTN).

FIG. 4 shows the Home Network or HPLMN having some additional elements, including a Proxy-Call Session Control Function (P-CSCF) 402, another Call Session Control Function (CSCF) 404, a Media Gateway Control Function (MGCF)/media gateway (MGW) 406, and the PSTN 408. In some implementations, the P-CSCF 402, CSCF 404, and MGDF/MGW 406 may be part of the IMS 232.

In stage (A), attachment procedures are performed in the same manner described for FIG. 3 (such as one or more of attachment requests in stage (A) of FIG. 3, authentication in stage (B) of FIG. 3, creating a session and radio resource connection configuration in stages (C)-(E), and so on). Nevertheless, the example of FIG. 4 involves connections for voice calls rather than an Internet data session.

The IP address for the P-CSCF 402 is in the IP Multimedia Services Identity Module (ISIM), which resides on the Universal integrated circuit card (UICC) of the user device 172-1. As an alternative, the IP address of the P-CSCF 402 can be obtained using a Dynamic Host Configuration Protocol (DHCP) server.

In stage (B), the user device 172-1 initiates a phone call by dialing a destination number to a SIP phone. The SIP invite message is sent through the subsystem 110 and the in-country satellite backhaul link, where the SIP invite is handled by the components of the core network 160 and/or IMS 232, and ultimately connected through Signaling System 7 (SS7). Additional SIP call signaling then proceeds and voice traffic is exchanged over the network until the call is finished and the connection is terminated.

In stage (C), as another example, the user device 172-1 initiates a phone call by dialing a destination number to a phone in the PSTN 408. Initiating a call to a PSTN telephone begins with a SIP invite message that is sent through the subsystem 110 and the in-country satellite backhaul link, where the SIP invite is handled by the components of the core network 160 and/or IMS 232, and ultimately connected through Signaling System 7 (SS7). Additional SIP call signaling then proceeds and voice traffic is exchanged over the network until the call is finished and the connection is terminated. In general, the process for a call to a PSTN phone in stage (C) is the same as for a call to a SIP phone in stage (B), except that there when the destination is a PSTN phone, there will be conversion from SIP to SS7 and vice versa which is done by MGCF/MGW 406.

When using a split backhaul there are multiple options that can be used for IP address allocation. As one example, the HPLMN allocates the IP address to the UE when the default bearer is activated (dynamic or static HPLMN address). As another example, the VPLMN allocates the IP address to the UE when the default bearer is activated (dynamic VPLMN address). As another example, the PDN operator or administrator allocates an (dynamic or static) IP address to the UE when the default bearer is activated (External PDN Address Allocation).

To support DHCP-based IP address configuration, the PGW 214 can act as the DHCP server towards the user device 172-1 for both HPLMN-assigned dynamic and static IP addressing and for VPLMN-assigned dynamic IP addressing. The signaling radio bearer (SRB) is used to carry Non Access Stratum (NAS) messages, such as an attach request. There are two Default Bearers and so two Access Point Names (APNs). The default bearer for SIP (QCI 5) results in a first APN (e.g., APN 1). A dedicated bearer is used for VoIP (QCI 1), and a default bearer for Data (QCI 9) results in a second APN (e.g., APN 2). The user device 172-1 will have two IP addresses—one associated with APN 1 and the other with APN 2.

Many examples described herein show how techniques can be applied in a 4G/LTE network, such as when the base station 104 is a 4G eNB, the subsystem 110 implements an EPC, and so on. Nevertheless, the same techniques of using a split satellite backhaul are applicable to other protocols and networking technologies. As an example, the techniques can be applied in 5G networks, with the base station 104 as a 5G gNB, the subsystem 110 implementing a 5GC, and so on.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them.

Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. A system comprising:
a first satellite terminal configured to communicate over a first satellite network connection with a first satellite gateway located in a first geographic region;
a second satellite terminal configured to communicate over a second satellite network connection with a second satellite gateway located in a second geographic region; and
a communication subsystem that is configured to concurrently communicate with the first satellite terminal and the second satellite terminal, wherein the communication subsystem is configured to use the first satellite network connection and the second satellite network connection as backhaul links for one or more wireless base stations,
wherein the communication subsystem has a communication interface for communication with the one or more wireless base stations, wherein the communication interface is configured to send and receive traffic for the one or more wireless base stations, and
wherein the communication subsystem is configured to split the traffic among the first satellite network connection and the second satellite network connection such that (i) a first category of traffic is provided over the first satellite network connection and (ii) a second category of traffic is provided over the second satellite network connection.

2. The system of claim 1, wherein the communication interface is configured to send and receive voice traffic and data traffic for the one or more wireless base stations;
wherein the first satellite network connection has a lower latency than the second satellite network connection;
wherein the first category of traffic is voice traffic, such that the communication subsystem is configured to provide voice traffic over the first satellite network connection of the first satellite terminal; and
wherein the second category of traffic is data traffic, such that the communication subsystem is configured to provide the data traffic over the second satellite network connection of the second satellite terminal.

3. The system of claim 2, wherein the communication subsystem is configured to exchange, over the first satellite networking connection, signaling messages for setting up or terminating communication sessions.

4. The system of claim 2, wherein the first satellite network connection comprises a satellite link with a first satellite, and the first satellite gateway is located in a first country that is the same country where the base station is located; and
wherein the second satellite network connection comprises a satellite link with a second satellite, and the second satellite gateway is located in a second country.

5. The system of claim 1, wherein the first satellite network connection and the second satellite network connection comprise different physical network paths, including communication through at least a different frequency band, physical channel, satellite beam, or satellite.

6. The system of claim 1, wherein the first satellite terminal is a first very small aperture terminal (VSAT) and the second satellite terminal is a second VSAT.

7. The system of claim 1, wherein the communication subsystem comprises a local core network that is co-located with the first satellite terminal and the second satellite terminal.

8. The system of claim 1, wherein the communication subsystem comprises a 3rd Generation Partnership Project (3GPP) long-term evolution (LTE) Evolved Packet Core (EPC) or a 3GPP fifth generation (5G) core (5GC).

9. The system of claim 1, wherein the communication interface comprises at least one of (i) a LTE S1 interface or a (ii) 5G Next Generation (NG) interface.

10. The system of claim 1, wherein the communication subsystem comprises:
a serving gateway that provides the communication interface for communication with the one or more wireless base stations; and
a packet gateway that is configured to split voice traffic and data traffic among the satellite network connections.

11. The system of claim 10, wherein the communication subsystem comprises:
a mobility management entity configured to manage access to network connections by user equipment; and
a policy and charging rules function that is configured to perform data flow detection, policy enforcement, and charging for network resource use.

12. A method comprising:
establishing multiple concurrent satellite network connections, the satellite networking connections comprising (i) a first satellite network connection involving a first satellite gateway in a first geographic region, and (ii) a second satellite network connection involving a second satellite gateway located in a second geographic region;
communicating with one or more wireless base stations to send traffic to and receive traffic from the one or more wireless base stations; and
splitting backhaul communication among the multiple concurrent satellite network connections to route different categories of traffic for the one or more wireless base stations over different satellite network connections, including (i) routing traffic that is in a first category to the first satellite network connection, and (ii) routing traffic that is in a second category to the second satellite network connection.

13. The method of claim 12, wherein the first satellite network connection has a lower latency than the second satellite network connection.

14. The method of claim 12, wherein the first geographic region is a first country, and wherein the second geographic region is a second country that is different from the first country;
wherein the one or more wireless base stations are located in the first country;
wherein the first category comprises voice traffic, such that the voice traffic is routed over the first satellite network connection involving the first satellite gateway that is located in the first country; and
wherein the second category comprises Internet data traffic, such that the Internet data traffic is routed over the second satellite network connection involving the second satellite gateway that is located in the second country.

15. The method of claim 12, wherein the different categories of traffic are different quality of service classes.

16. The method of claim 12, wherein the first satellite network connection comprises a satellite link with a first satellite, and the first satellite gateway is located in a first country that is the same country where the one or more wireless base stations are located; and
wherein the second satellite network connection comprises a satellite link with a second satellite, and the second satellite gateway is located in a second country.

17. The method of claim 12, wherein the first satellite network connection and the second satellite network connection comprise different physical network paths, including communication through at least a different frequency band, physical channel, satellite beam, or satellite.

18. The method of claim 12, wherein splitting backhaul communication among the multiple concurrent satellite network connections comprises routing signaling traffic for the first satellite network connection and the second satellite network connection over the first satellite network connection.

19. The method of claim 12, wherein splitting the backhaul communication is performed by a 3rd Generation Partnership Project (3GPP) long-term evolution (LTE) Evolved Packet Core (EPC) or a 3GPP fifth generation (5G) core (5GC).

20. One or more non-transitory machine-readable media storing instructions that are operable, when executed by one or more processors of one or more communication devices, to cause the one or more communication devices to perform operations comprising:
establishing multiple concurrent satellite network connections, the satellite networking connections comprising (i) a first satellite network connection involving a first satellite gateway in a first geographic region, and (ii) a second satellite network connection involving a second satellite gateway located in a second geographic region;
communicating with one or more wireless base stations to send traffic to and receive traffic from the one or more wireless base stations; and
splitting backhaul communication among the multiple concurrent satellite network connections to route different categories of traffic for the one or more wireless base stations over different satellite network connections, including (i) routing traffic that is in a first category to the first satellite network connection, and (ii) routing traffic that is in a second category to the second satellite network connection.
